(19) United States
(12) Patent Application Publication
(10) Pub. No.: US 2009/0034776 A1
(43) Pub. Date: Feb. 5, 2009

(54) PANEL-ACOUSTIC TRANSDUCER COMPRISING AN ACTUATOR FOR ACTUATING A PANEL, AND SOUND-GENERATING AND/OR RECORDING DEVICE

(75) Inventors: Georgo Zorz Angelis, Eindhoven (NL); Martijn Roger La Grange, Eindhoven (NL); Bert Roozen, Eindhoven (NL); Rick Scholte, Enschede (NL); Marco Adrianus Hendrikus Koevoets, Eindhoven (NL); Abram Jan Den Hamer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,011

(22) PCT Filed: Jul. 21, 2005
(86) PCT No.: PCT/IB05/52462

§ 371 Date: May 2, 2008

(30) Foreign Application Priority Data
Aug. 6, 2004 (EP) 04103787.0

(51) Int. Cl. H04R 1/02

(52) U.S. Cl. 381/386

(57) ABSTRACT

A panel-acoustic transducer comprises a plate-like actuator (4) and a panel (5). The panel (5) has two substantially perpendicular axes of symmetry (A_{S},Aₗ). The plate-like actuator (4) is coupled to the panel in such a way that: —the actuator (4) is coupled to the panel substantially symmetrically with respect to both symmetry axes (A_{S},Aₗ) of the panel (4); the plate-like actuator (4) is so arranged that, in operation, at least the first five odd excitation modes ((1,1), (3,1), (1,3), (3,3), (5,1)), in order of increasing frequency, are actuated with alternating signs. Cusps in the power spectrum of the transducer are thereby prevented.

### FIELD OF THE INVENTION

The invention relates to a panel-acoustic transducer comprising an actuator for actuating a panel.

Panel acoustic transducers are in particular panel speakers and panel microphones.

Panel speakers are used for sound-generating devices, such as loudspeakers, whether used as a stand-alone device or as a part of another device such as a mobile telephone, radio, television, etc. Panel microphones are used to record sound.

The invention also relates to a sound-generating and/or a sound-recording device comprising a panel-acoustic transducer.

### BACKGROUND OF THE INVENTION

There are many actuators that may be used for actuating a panel of an acoustic transducer, for example, using a moving coil, a moving magnet, etc.

Among these various types of actuators, piezoelectric actuators are popular because of their high efficiency. Whereas for other types of actuators much if not most of the energy is lost to heat, piezoelectric actuators or transducers, as they are sometimes also called, offer a high efficiency. The invention uses a plate-like transducer, such as a piezoelectric actuator, or a magnetostrictive actuator. Piezoelectric materials occur in a variety of forms as natural crystalline minerals, such as quartz, and manufactured crystalline and other materials, such as plastic materials, including films and foams. These materials are considered to be suitable for the acoustic transducer according to the invention. Furthermore, piezoelectric materials are merely used as being illustrative of thin sheet-like or plate-like materials that may appropriately be used to form transducers. Such transducers may be magnetostrictive transducers, electromagnetic transducers, electrostatic transducers, micro-motors, etc. Because of their high efficiency, piezoelectric transducers and magnetostrictive transducers are preferred embodiments of plate-like actuators.

Piezo-actuated panel speakers and microphones are expected to become more and more interesting in the near future, because they outperform traditional voice-coil actuators as regards added mass, power consumption and claimed volume. This is especially important in demanding applications such as mobile phones, PDAs, flat panel displays, etc. It is to be noted that, within the concept of the invention, the panel-acoustic transducer may have a flat or a curved panel. The panel may perform a double function such as a so-called singing or swinging display, wherein the panel acts as a display panel and as a sound-generating means.

There is a drive to increase the performance of such devices.

In U.S. Pat. No. 5,196,755, the performance is improved in that the radiated sound is enhanced by increasing the number of elements. Increasing the number of actuating elements is also disclosed in U.S. Pat. No. 6,278,790. Although an increase of the number of actuating elements does enhance the radiated sound and, especially if such elements are driven separately, enhances the degrees of freedom and the control over the radiated sound, this also complicates the design and manufacture of the panel speaker.

As regards their ability to generate sound, the performance of the acoustic transducers such as e.g. speakers is often quantified by measuring sound power or pressure levels at certain distances from the speaker for a broad range of frequencies at which the piezo-speaker, i.e. the panel speaker with a piezo-actuator, is actuated. Preferred sound pressure characteristics show a flat spectrum with a sufficiently high level for a broad range of frequencies. Similar performance criteria apply when recording sound.

### OBJECT AND SUMMARY OF THE INVENTION

It is an object of the invention to provide a relatively simple design having a relatively flat spectrum with a relatively high level for a relatively broad range of frequencies.

To this end, the panel-acoustic transducer according to the invention is characterized in that the panel of the panel-acoustic transducer has two substantially perpendicular axes of symmetry, wherein a plate-like actuator, preferably a piezoelectric actuator, is coupled to the panel, such that:
the actuator is coupled to the panel substantially symmetrically with respect to both the symmetry axes of the panel;
the plate-like actuator is so arranged that, in operation, at least the first five odd excitation modes, in order of increasing frequency, are actuated with alternating signs.

The invention is based on the following recognition.

The produced sound quality, i.e. Sound Pressure Level (SPL) in the relevant frequency range (range from e.g. 500 [Hz] up to e.g. 10 [kHz]) depends on the actual design, i.e. the design of the plate-like actuator, preferably a piezoelectric actuator, with respect to the design of the panel.

As regards their ability to make sound, the performance of the transducers such as e.g. speakers is often quantified by measuring sound pressure levels at certain distances from the speaker for a broad range of frequencies at which the piezo-speaker is actuated. Preferred sound pressure characteristics show a more or less flat spectrum with a sufficiently high level for a broad range of frequencies. Sound pressure drops, i.e. dips in the spectrum, reduce the sound production or recording quality. The measures of the invention to solve or at least reduce this problem are based on the following new understanding. Sound pressure levels can often be related (proportionally) to net volume velocity of the panel that is actuated by means of the piezo. The net volume velocity is the sum of the modal volume contributions. The modal contribution (to net volume velocity) is a function of the geometry of the panel and the geometry of the piezo as well as its positioning on the specific panel. Mathematical calculations prove and experiments show that if 1) only the modes that contribute to volume velocity are actuated (the even mode is thus not substantially actuated) and if 2) the sign pattern of the modal contributions alternates between positive and negative for increasing frequency, anti-resonances (drops, dips in the sound pressure) are avoided up to a frequency for which the above conditions hold, which in the invention is up to at least the fifth (often the (5,1)) odd mode. Due to the fact that the panel with the plate-like actuator can also be used as a sensor, the design (rule) is also applicable to flat-panel microphones.

Most preferably, the plate-like actuator is a single actuator.

In a preferred embodiment, in which the panel has an elongated shape and comprises a central part (C), an east (E), west (W), north (N), south (S), northeast (NE), northwest (NW), southeast (SE) and southwest (SW) part, where the east-west axis corresponds to the shorter one of the symmetry axes of the panel, and the north-south axis corresponds to the longer one of the symmetry axes, the coupling of the piezoelectric actuator to said parts is as follows:
F(E)≈F(W)=A*F(C), where 0≦A⁻¹≦1 where F(E) is the coupling in the east part, F(W) is the coupling in the west part and F(C) is the coupling in the central part, and
the coupling in the other parts is substantially smaller than the coupling in the east part.

The above-mentioned conditions, i.e. design rules, imposed on a piezo-speaker or a microphone (geometry and positioning) lead to the above rules when an elongated panel (such as a rectangular or oval or rectangularly shaped panel) is concerned. The piezoelectric actuator is positioned symmetrically with respect to the panel and has the non-trivial shape of a dumbbell-like shape, with a relatively large coupling in the east and west parts, a moderate coupling in the central part (between 0 and 100% of east and west) and substantially no coupling in the other parts. Measurements confirm the predicted performance.

The value of A⁻¹ is preferably between 0.25 and 1, more preferably between 0.25 and 0.75.

Within the concept of the invention, the term “approximately equal”, represented above by the sign ≈, indicates that the difference between the values is less than 10%, preferably less than 5%, more preferably less than 2%. “Substantially symmetrical” also means a difference of less than 10%, preferably less than 5%, more preferably less than 2%. “Substantially smaller” means less than 20%, preferably less than 10%, more preferably less than 5%, most preferably substantially negligible.

These and further aspects of the invention will be explained in greater detail by way of example and with reference to the accompanying drawings.

### BRIEF DESCRIPTION OF THE DRAWINGS

FIG. 1 schematically shows a system for driving a piezoelectric actuator.

FIG. 2 schematically shows a panel with a piezoelectric actuator attached.

FIG. 3 schematically shows a panel speaker with a piezoelectric actuator.

FIG. 4 illustrates various excitation modes of a panel and a round central actuator.

FIG. 5 illustrates, in a graphical form, the driving efficiency as a function of frequency for an arrangement with a centrally located round piezoelectric actuator.

FIG. 6 illustrates excitation modes for a panel with a round actuator having a larger diameter than that shown in FIG. 4.

FIG. 7 illustrates, in a graphical form, the driving efficiency as a function of frequency for an arrangement with a centrally located round piezoelectric actuator as shown in FIG. 6.

FIG. 8 illustrates the phase as a function of frequency for the arrangement shown in FIG. 6.

FIG. 9 illustrates a design example according to the invention.

FIG. 10 illustrates, in a graphical form, the driving efficiency for the arrangement shown in FIG. 9.

FIG. 11 illustrates the phase as a function of frequency for the arrangement of FIG. 9.

FIG. 12 illustrates the difference in driving efficiency between FIGS. 8 and 10.

FIG. 13 illustrates a basic principle of the invention.

FIG. 14 illustrates various abbreviations used.

FIG. 15 illustrates various variations of the design shown in FIG. 9.

FIG. 16 illustrates a different variation of the design.

FIG. 17 illustrates the driving efficiency as a function of parameter A^{31 1}.

FIG. 18 further illustrates the driving efficiency as a function of parameter A⁻¹.

FIG. 19 shows yet a further example of the invention.

The Figures are not drawn to scale. Generally, identical components are denoted by the same reference numerals in the Figures.

### DESCRIPTION OF EMBODIMENTS

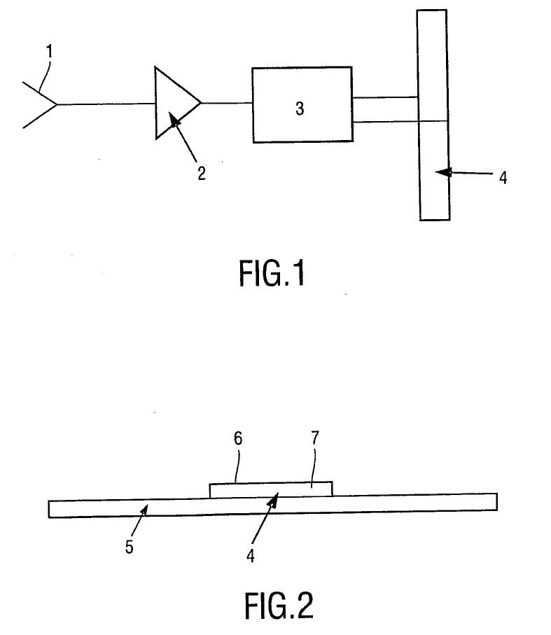

FIG. 1 schematically shows a prior-art system for a panel speaker in a block diagram. An audio signal 1 is fed to an amplifier 2 which provides a signal “boost” or amplification. The output of the amplifier 2 may be fed to a transformer 3 to increase the voltage swing at the piezoelectric element 4.

FIG. 2 illustrates schematically an example of an assembly of the piezoelectric speaker with a panel and a piezoelectric actuator. The piezoelectric actuator 4 is arranged on the surface to be excited, in this case a panel diaphragm 5. A signal is fed to the piezoelectric actuator via leads 6, 7.

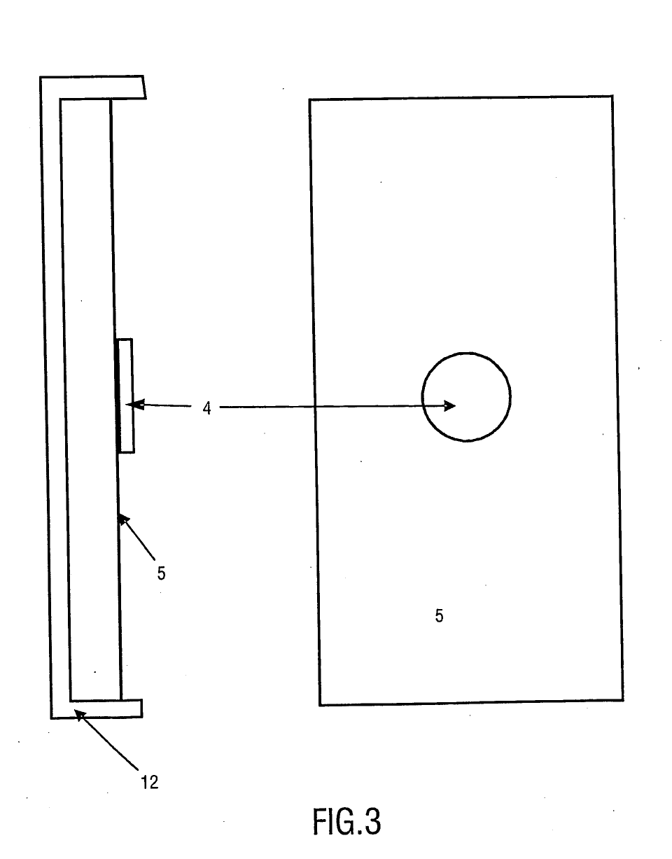

FIG. 3 illustrates one possible flat panel speaker design. A piezoelectric element 4 is bonded to the centre of panel 5 within a resonator cabinet 12.

As regards their ability to generate sound, the performance of the speakers is often quantified by measuring sound power or pressure levels at certain distances from the speaker for a broad range of frequencies at which the piezo-speaker is actuated. Superior and preferred sound pressure characteristics show a flat spectrum with a sufficiently high level for a broad range of frequencies. Sound pressure drops, i.e. dips in the spectrum, lead to a reduced sound reproduction. It has appeared that, as is done in prior-art designs, providing a piezoelectric actuator in the central region leads to a sudden sound pressure level, i.e. quite sudden drops in the sound pressure level as a function of frequency. It has further appeared that, by properly following certain design rules, such drops in the sound pressure level may be prevented or at least partially reduced.

Flexible structures such as flat panels have resonances, which can be characterized for rectangular panels by two numbers indicating the number of half wavelengths along the two axes. The lowest frequency is (1,1). The frequency increases as the numbers increase.

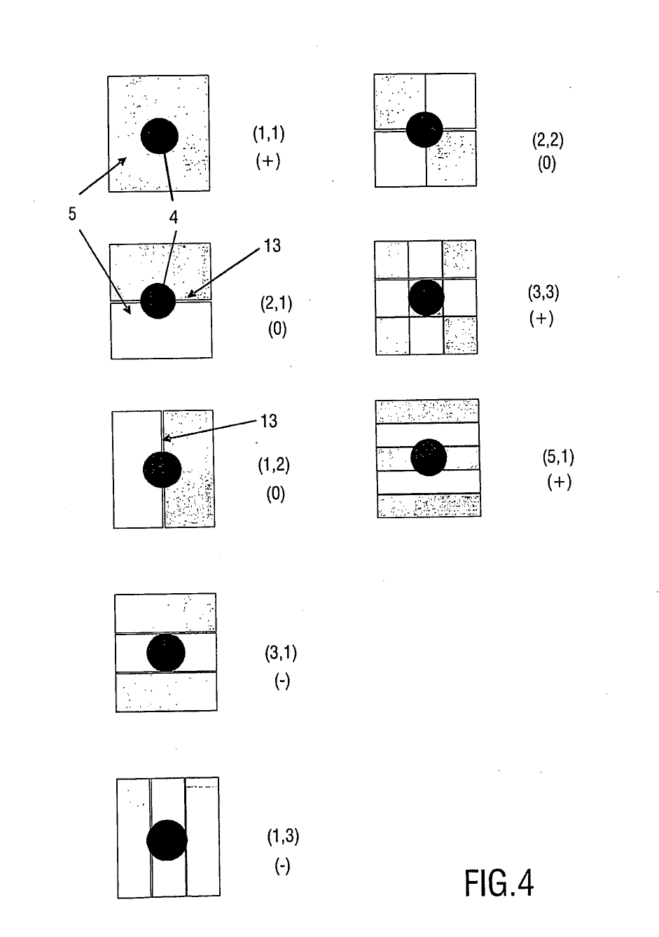

FIG. 4 illustrates schematically the lowest modes for a substantially rectangular panel (i.e. having two axes of symmetry). Within the scope of the invention, substantially rectangular may be oval, square or with rounded corners. The lowest frequency mode is the (1,1) mode, which has nodes (zero amplitude positions) along or near the edges of the panel. The amplitude is either positive or negative everywhere, depending on the phase of the wave. In the Figure, the amplitude is taken to be positive. The (2,1) mode has a node along the short axis, the (1,2) mode has a node along the long axis, the (2,2) mode has a node along the short and the long axis, etc. For each mode up to the (5,1) mode, the nodes and the sign of the amplitude are given, wherein grey stands for a positive and white for a negative displacement or strain. FIG. 4 illustrates a simple piezoelectric actuator 4 attached at the centre of the panel 5. The effect of the actuator on the mode can be calculated, basically by adding and subtracting positive (grey) and negative (white) contributions. The net result is as follows.

| | Mode | | | | | | | |
|---|---|---|---|---|---|---|---|---|
| | 1, 1 | 2, 1 | 1, 2 | 3, 1 | 1, 3 | 2, 2 | 3, 3 | 5, 1 |
| Net | + | 0 | 0 | − | − | 0 | + | + |

The net result for the (2,1), (1,2), (2,2) and higher order symmetrical modes is substantially zero due to the symmetry of the position and shape of the actuator with respect to the axes of symmetry. The higher order symmetrical modes are omitted in the Table above.

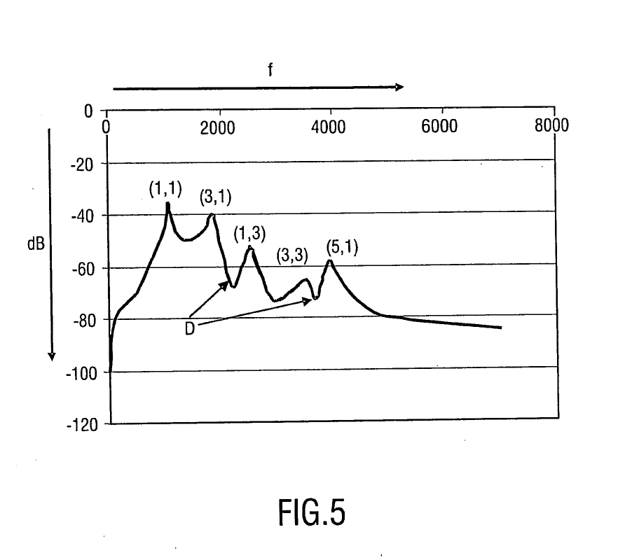

FIG. 5 illustrates as a function of frequency (f [Hz]) the driving efficiency, expressed in dB. Peaks are visible at the resonance frequencies (indicated by their modes number (n,m)). However, sharp dips D are apparent in between the peaks. The drops correspond to those points where neighboring modes have the same amplitude but an opposite phase, i.e. between the (3,1) and (1,3) peak and between the (3,3) and (5,1) peak. Such sound pressure drops, i.e. dips in the spectrum, reduce the sound production or recording quality. Basically, the ability to produce or record sound at such dips is strongly reduced. The same phenomenon occurs when recording sound.

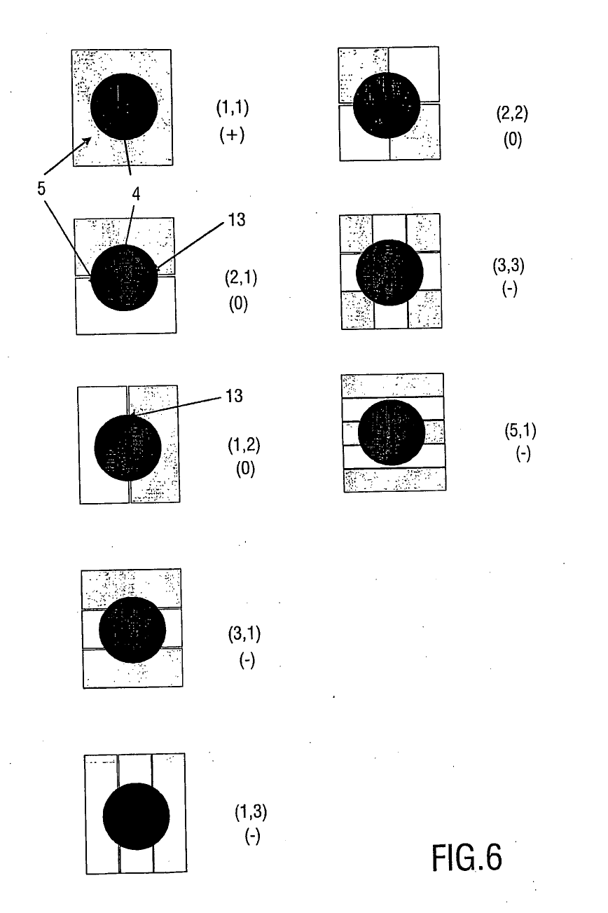

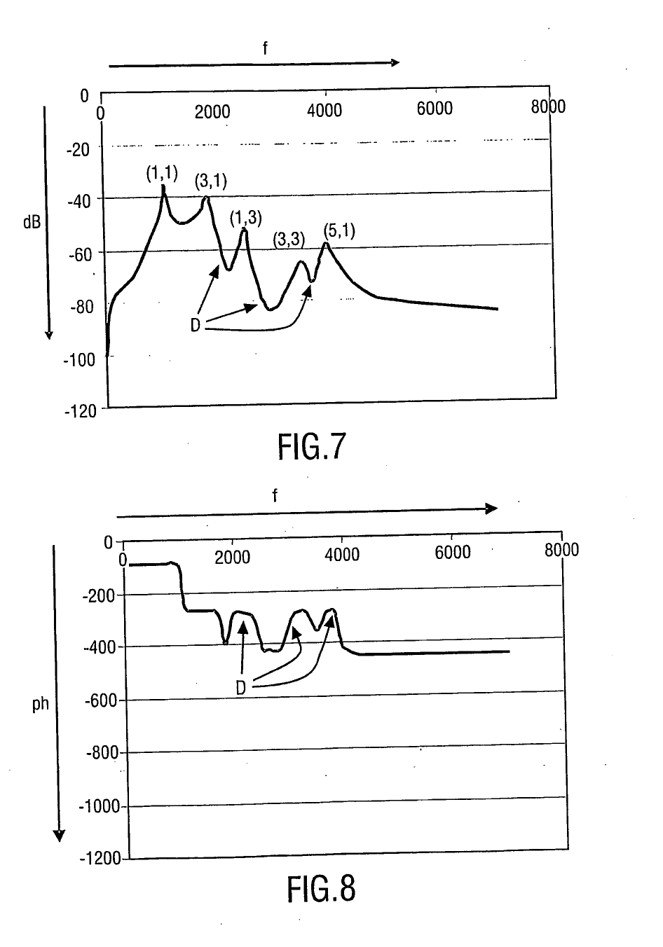

FIG. 6 illustrates a design which has a larger central actuator. A larger actuator will generally give more power, but the sign of the (3,3) and (5,1) modes is changed from positive to negative. FIG. 7 shows the result for the driving efficiency, where a strong dip is apparent between the (1,3) and the (3,3) peak. Thus, simply increasing or decreasing the size of the centrally located actuator does not lead to a solution for the dips in the spectrum.

This can be represented as follows.

| | Mode | | | | | | | |
|---|---|---|---|---|---|---|---|---|
| | 1, 1 | 2, 1 | 1, 2 | 3, 1 | 1, 3 | 2, 2 | 3, 3 | 5, 1 |
| Net | + | 0 | 0 | − | − | 0 | − | − |

It is an object of the invention to reduce this negative effect.

FIG. 8 illustrates the phase as a function of frequency for the design shown in FIG. 6. The position of the dips is shown. The dips correspond to those situations, see FIG. 4, in which two succeeding modes (n,m) have the same sign, for instance, between the (1,3) and the (3,1) mode.

The invention is based on the recognition that the problems are reduced under the following conditions:
the piezoelectric actuator is coupled to the panel substantially symmetrically with respect to both symmetry axes of the panel;
the piezoelectric actuator is so arranged that the first five odd excitation modes are actuated, in operation, with alternating signs.

The symmetrical arrangement means that only the odd modes (1,1), (1,3), (3,1), (3,3), (5,1), etc. are excited, i.e. only those modes (n,m) wherein n and m are both odd. This increases the net volume velocity. The net volume velocity is nothing else than the sum of the modal volume contributions. The modal contribution (to net volume velocity) is a function of the geometry of the panel and the geometry of the piezo as well as its positioning on the specific panel. Mathematical calculations prove and experiments show that the net volume velocity is high if 1) only the modes that contribute to volume velocity are actuated, and if 2) the sign pattern of the modal contributions alternates between positive and negative for increasing frequency, anti-resonances (drops, dips in the sound pressure) are avoided up to a frequency for which the above conditions hold, which in the present invention is at least the fifth mode (in the example, this is the (5,1)-mode). It is noted that, in reality, a perfect symmetry with respect to the axes of symmetry may not be obtainable. Within the scope of the present invention, the actuator is substantially symmetric if it is symmetric to within 10%, preferably to within 5%, more preferably to within 2% of the axes of symmetry of the panel. When discussed in terms of power levels of odd and even modes, the actuator is deemed to be substantially symmetric when the power level of even modes (i.e. modes in which n and/or m are even), within the relevant frequency range (the range from the first peak up to the fifth or sixth even mode), is substantially below the power level of the odd modes, preferably more than 15 dB, and preferably more than 30 dB below the power level of the odd modes.

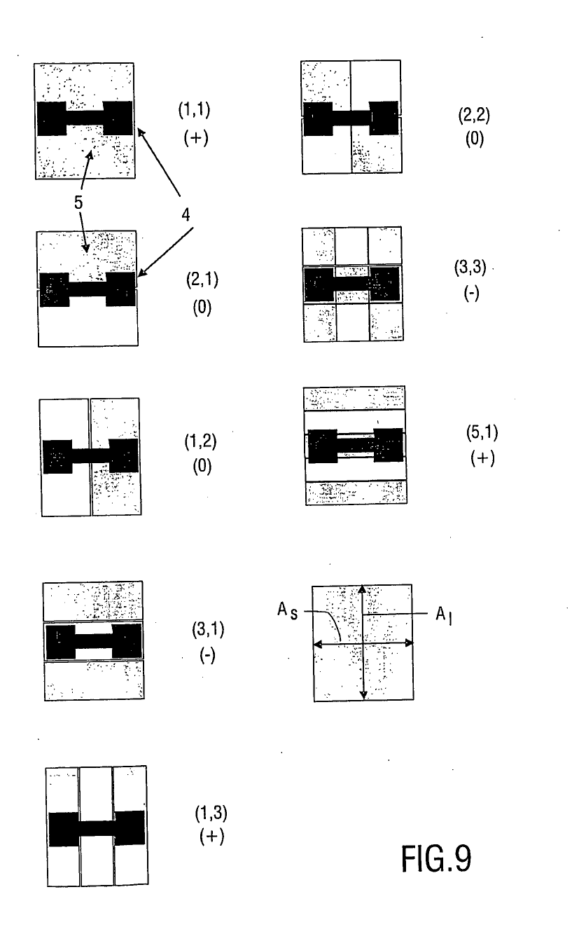

FIG. 9 illustrates a design example which obeys these rules.

The even modes are substantially not driven, and the odd modes up to at least the fifth mode in order of increasing frequency are driven with alternating signs.

| | Mode | | | | | | | |
|---|---|---|---|---|---|---|---|---|
| | 1, 1 | 2, 1 | 1, 2 | 3, 1 | 1, 3 | 2, 2 | 3, 3 | 5, 1 |
| Net | + | 0 | 0 | − | + | 0 | − | + |

The sign alternates for the first 5 odd modes. The long and short symmetry axes Aₛ and Aₗ are shown in the last part of FIG. 9.

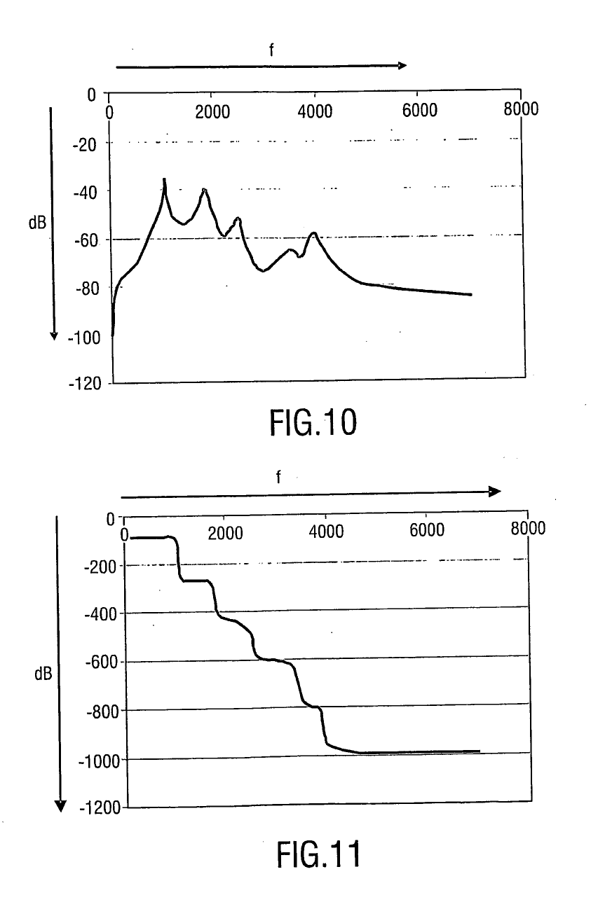

FIG. 10 illustrates the driving efficiency. Although the resonant peaks are still clearly visible, the dips are much less pronounced (a difference of 15 to 20 dB).

FIG. 11 illustrates the phase of the design shown in FIG. 9. The phase is a constantly decreasing function of frequency.

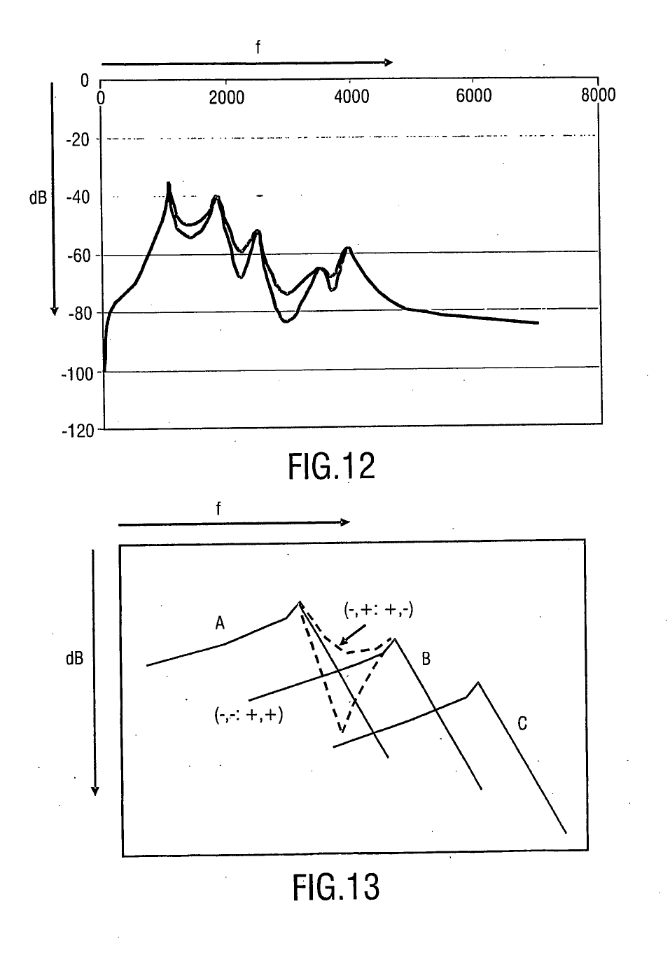

FIG. 12 illustrates the difference in driving efficiency. The dips in the graph of FIG. 10 are much more pronounced (approximately 15 to 20 dB) than in the graph of FIG. 8. Consequently, a better sound reproduction (or sound recording) is achieved. When a substantially rectangular panel is used, a preferred arrangement is defined by the following characteristic features.

The panel has an elongated shape and comprises a central part (C), an east (E), west (W), north (N), south (S), northeast (NE), northwest (NW), southeast (SE) and southwest (SW) part, where the east-west axis corresponds to the shorter one (Aₛ) of the symmetry axes of the panel, and the north-south axis corresponds to the longer one (Aₗ) of the symmetry axes, and the coupling of the piezoelectric actuator to said parts is as follows:
F(E)≈F(W)=A*F(C), where 0≦A₋₁≦1 where F(E) is the coupling in the east part, F(W) is the coupling in the west part and F(C) is the coupling in the central part, and
the coupling in the other parts is substantially smaller than the coupling in the east part.

A value of 0 for A⁻¹ means that there are two separate actuators, one each in the east and west part.

A value of A⁻¹=1 is, for instance, a band of equal length through the east, central and west parts.

A value of A⁻¹=0.5 is, for instance, a dumbbell shape as shown in FIG. 9.

Preferably it holds that 0.25≦A⁻¹≦1, more preferably 0.25≦A₋₁≦0.75.

FIG. 13 illustrates a basic principle of the invention. This Figure shows the driving efficiency versus frequency in a graphical form. When two volume modes A, B are considered (for instance, the (3,1) and the (1,3) mode), the driving efficiency in the region in between the peaks may either follow a saddle-type curve (denoted by (−,+:+−) in the Figure) or a cusp-like curve (denoted by (−,−:+,+)). A saddle-type curve occurs if the signs of the neighboring volume modes are operated with an opposite sign. In that case, the efficiencies add up in the region in between the peaks, and the curve thus has a minimum at about 6 dB a factor of 2) above the point where the curves cross. A cusp-type curve occurs if the signs of the neighboring volume modes are operated with the same sign. In that case, the efficiencies are subtracted from each other in the region in between the peaks. When only these two modes are considered, the efficiency would drop to −∞. However, in reality, the deepest point of the cusp equals the efficiency of a higher order mode. Typically, this is some 5 to 20 dB below the cross-point, i.e. the difference between the one and the other condition is 10 to 25 dB, which is a notable difference. By measuring the efficiency as a function of frequency, it may be easily determined whether a saddle-like region or a cusp-like region is present in between peaks. To do this, the behavior immediately next to the peaks is analyzed, the hypothetical lines from this analysis are extended in the intermediate region until they cross, and the form of the efficiency curve with respect to the cross-point is determined. Within a device according to the invention, there is a saddle-like behavior between the first five odd modes.

The arrangements shown in FIG. 9 obey these rules. The overall shape in these examples is a dumbbell-like shape lying along the short axis of the rectangular panel. Adding coupling to other parts (NW, N, NW, SW, S, SE) would increase the driving efficiency in some lower modes, but would reduce the driving efficiency in higher modes. The same is true for increasing the coupling in the central part.

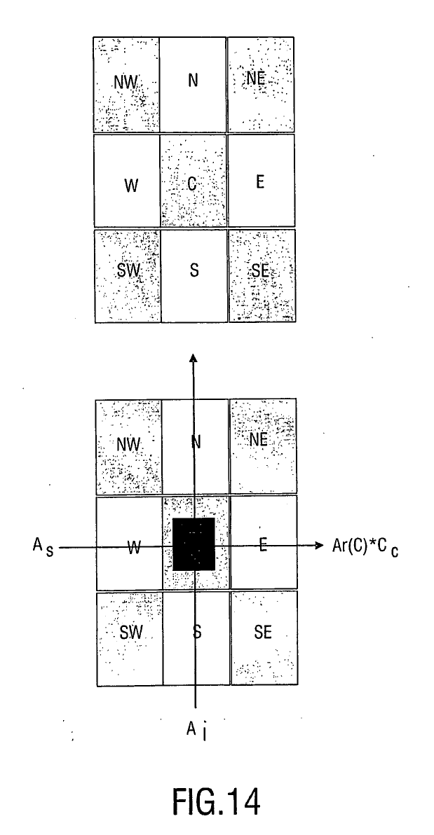

FIG. 14 illustrates the various abbreviations used. The coupling within a part is the area Ar of the piezoelectric actuator within this part times the coupling coefficient Cc. The coupling coefficient will often be the same for all parts, because the same type of attachment will often be used throughout the piezoelectric element, in which case the ratios between the couplings are simply the ratios between the areas by the piezoelectric element within the relevant parts.

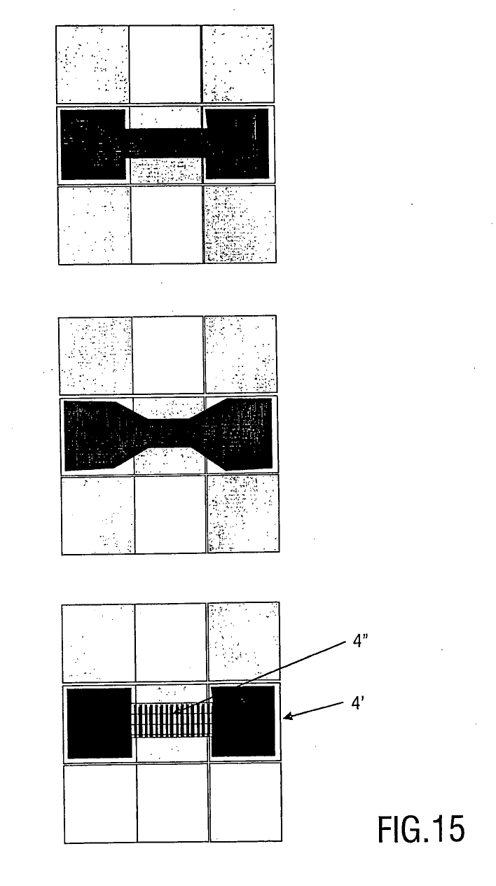

FIG. 15 illustrates various variations of the design shown in FIG. 9. The upper part of the Figure shows the arrangement as shown in FIG. 9, the middle part shows a slightly changed arrangement, and the bottom part shows an arrangement in which the piezoelectric actuator is divided into two sub-actuators 4′, 4″, one at each side of the panel, wherein 4″ is approximately half (between 25% and 75%) of the size of the actuator 4′.

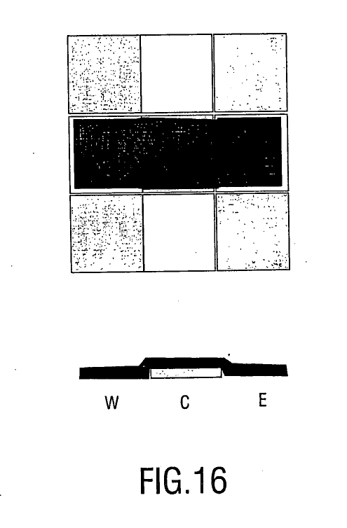

FIG. 16 illustrates different variations of the design. The piezoelectric actuator itself is a simple band structure covering the E, C and W parts. However, at the central part, the coupling between the actuator and the panel is reduced (by between 25% and 75%) by an intermediate layer.

It will be clear that many variations are possible within the scope of the invention.

For instance, in a preferred embodiment, the flat-like actuator is a piezoelectric actuator. In another preferred embodiment, the actuator is a single actuator, i.e. made in one piece. This is a very simple and cost-effective embodiment.

The panel may be substantially rectangular, but it may alternatively have one or more round corners. Corners at an angle of 90° may provide problems as regards efficiency. Rounded corners may be more efficient.

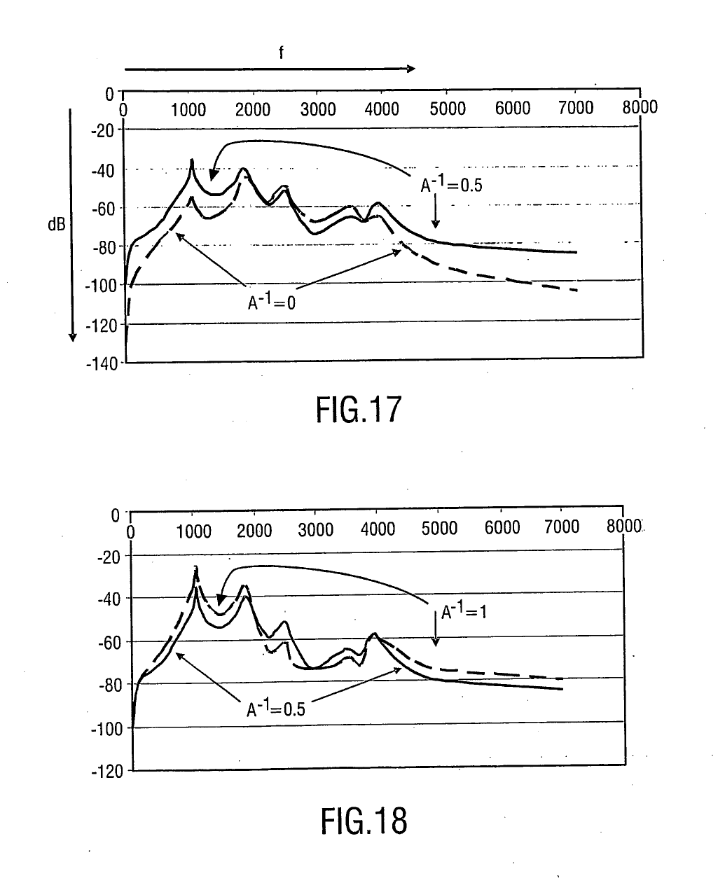

FIGS. 16 and 17 illustrate the behavior of the efficiency as a function of the parameter A⁻¹.

FIG. 16 shows the efficiency for A₋₁=0.5, i.e. a dumbbell as e.g. shown in FIG. 9 (the solid line), and for A^{31 1}=0, i.e. two actuator patches in the east and west parts (the dotted line). When comparing the curves, it becomes clear that the curve for A⁻¹=0 has a much smaller first ((1,1) mode) peak than the curve for A⁻¹=0.5. This first peak covers an important part of the spectrum and thus A⁻¹=0.5 is preferred to A⁻¹=0.

FIG. 17 shows the efficiency for A⁻¹=0.5, i.e. a dumbbell as e.g. shown in FIG. 9 (the solid line), and for A⁻¹=1, e.g. a band covering the east, central and west parts (the dotted line). When comparing the curves, it becomes clear that, although giving a somewhat better performance in the lowest peak, the curve for A⁻¹=1 shows a much larger difference in efficiency between the first number of peaks and the third and the fourth peak. This may result in a distortion of the sound signal and A⁻¹=0.5 is therefore preferred to A⁻¹=1. Calculations show that A⁻¹ preferably ranges between 0.25 and 1, more preferably between 0.4 and 0.6, and most preferably between 0.25 and 0.75.

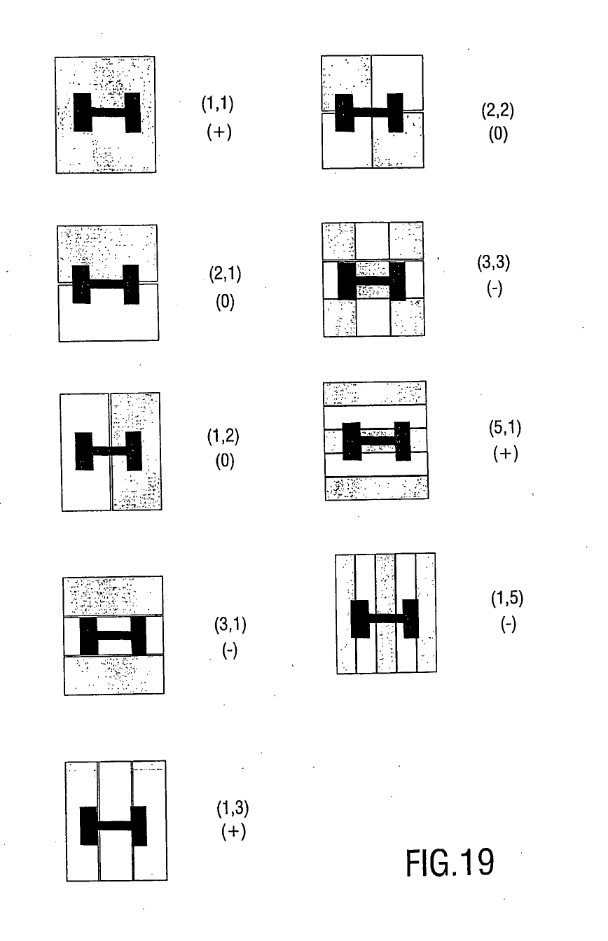

FIG. 19 shows yet a further example of the invention. The actuator has such a form that the first six odd modes are driven with alternating sign. This is preferred if one aims at extending the frequency range. However, when comparing this FIG. 19 with FIG. 9, it also becomes clear that the single actuator has a smaller area, which may reduce the maximum efficiency.

In summary, the invention may be described as follows.

A panel-acoustic transducer comprises a plate-like actuator. The panel of the panel speaker has two substantially perpendicular axes of symmetry, and a plate-like actuator is coupled to the speaker in such a way that:
the actuator is coupled to the panel substantially symmetrically with respect to both symmetry axes of the panel;
the plate-like actuator is so arranged that, in operation, at least the first five odd excitation modes, in order of increasing frequency, are actuated with alternating signs.

Cusps in the power spectrum of the acoustic transducer are thereby prevented.

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A panel-acoustic transducer comprising a plate-like actuator (4) for actuating a panel (5), which panel has two substantially perpendicular axes of symmetry (Aₛ, Aₗ), wherein the actuator (4) is coupled to the panel (5) substantially symmetrically with respect to both symmetry axes (Aₛ,Aₗ) of the panel (5), and the actuator (4) is so arranged that, in operation, at least the first five odd excitation modes ((1,1),(3,1),(1,3),(3,3),(5,1)), in order of increasing frequency, are actuated with alternating signs.

2. A panel-acoustic transducer as claimed in claim 1, wherein the plate-like actuator is so arranged that, in operation, at least the first six odd excitation modes ((1,1),(3,1),(1,3),(3,3),(5,1),(1,5)), in order of increasing frequency, are actuated with alternating signs.

3. A panel-acoustic transducer as claimed in claim 1, wherein the plate-like actuator (4) is a piezoelectric actuator.

4. A panel-acoustic transducer as claimed in claim 1, wherein the plate-like actuator is a single actuator.

5. A panel-acoustic transducer as claimed in claim 1, wherein the panel has an elongated shape and comprises a central part (C), an east (E), west (W), north (N), south (S), northeast (NE), northwest (NW), southeast (SE) and southwest (SW) part, where the east-west axis corresponds to the shorter one of the symmetry axes of the panel, and the north-south axis corresponds to the longer one of the symmetry axes, and wherein the coupling of the plate-like actuator to said parts is as follows:
F(E)≈F(W)=A*F(C), where 0≦A⁻¹≦1 where F(E) is the coupling in the east part, F(W) is the coupling in the west part and F(C) is the coupling in the central part, and
the coupling in the other parts is substantially smaller than the coupling in the east part.

6. A panel-acoustic transducer as claimed in claim 5, wherein 0.25≦A⁻¹≦1.

7. A panel-acoustic transducer as claimed in claim 5, wherein 0.25≦A⁻¹≦0.75.

8. A panel-acoustic transducer as claimed in claim 5, wherein the actuator has a dumbbell shape.

9. A panel speaker comprising the panel-acoustic transducer as claimed in claim 1.

10. A sound-generating and/or sound-recording device comprising a panel-acoustic transducer as claimed in claim 1.
